(19) United States
(12) Patent Application Publication
(10) Pub. No.: US 2020/0324579 A1
(43) Pub. Date: Oct. 15, 2020

(54) WINTER TIRE STUD ARRANGEMENT

(71) Applicant: The Goodyear Tire & Rubber Company, Akron, OH (US)

(72) Inventor: Frédéric Michel-Jean Pons, Thionville (FR)

(21) Appl. No.: 16/379,007

(22) Filed: Apr. 9, 2019

(51) Int. Cl. B60C 11/16

(52) U.S. Cl. CPC B60C 11/1625; B60C 11/1668; B60C 11/1681

(57) ABSTRACT

An arrangement of studs are inserted into a tread portion of a tire. The arrangement includes a plurality of first studs protruding from an unworn tread portion for contacting a surface and a plurality of second studs embedded in the tread portion such that the second studs protrude from a worn tread portion as the tread portion wears against the surface.

### FIELD OF INVENTION

The present invention relates to stud pins installed in a tread portion of a pneumatic tire and, more particularly, to a stud pin arrangement in the tread portion.

### BACKGROUND OF THE INVENTION

Conventional snow tires may be equipped with stud pins installed in the tread portion of the tire to allow the tire to grip an icy or snowy road surface. A stud pin may be embedded into a stud pin installation hole provided in the tread portion of the tire. The stud pin may broaden a pin bore and be tightly embedded therein so that the stud pin does not fall out of the stud pin installation hole due to braking, driving, or lateral and vertical forces received from the road surface while the tire is rotating.

The stud pin may have a pillar and a pin. The pillar may be fitted into a close-ended hole formed in the tread portion of the tire and thereby be secured to the tread surface. The pin may protrude radially outward from the pillar. The pillar may be asymmetrically and/or irregularly shaped as it extends radially outward from the tread portion.

When these studded snow tires are used on concrete or asphalt road surfaces not covered by snow or ice, these harder, bare road surfaces may dislodge the stud pins. Even for tires equipped with the above-mentioned stud pins, there are cases where the stud pins often fall out (pin drop) due to the forces on the tire while a vehicle is driving, braking, and/or cornering on a concrete or asphalt road. There will be a large amount of pin drop if there is any clawing force applied between the stud pin and the road surface. The clawing force may overcome the force retaining the stud pin in the tread rubber material of the tire. Therefore, there is a demand for further improvement regarding pin drop for these pneumatic stud tires, as well as the other performance characteristics of the stud pins (e.g., traction, durability, wear, etc.).

### SUMMARY OF THE INVENTION

In accordance with the present invention, an arrangement of studs are inserted into a tread portion of a tire. The arrangement includes a plurality of first studs protruding from an unworn tread portion for contacting a surface and a plurality of second studs embedded in the tread portion such that the second studs protrude from a worn tread portion as the tread portion wears against the surface.

According to another aspect of the arrangement, the first studs have radially outermost flat tip ends for contacting the surface.

According to still another aspect of the arrangement, the first studs have radially outermost spherical tip ends.

According to yet another aspect of the arrangement, the second studs have radially outermost flat tip ends for contacting the surface.

According to still another aspect of the arrangement, the second studs have radially outermost spherical tip ends.

According to yet another aspect of the arrangement, the first studs have a cylindrical stump portion.

According to still another aspect of the arrangement, the first studs have radially outermost flat tip ends and the second studs have radially outermost spherical tip ends.

According to yet another aspect of the arrangement, the first studs have radially outermost spherical tip ends and the second studs have radially outermost flat tip ends.

According to still another aspect of the arrangement, a plurality of third studs are embedded in the tread portion such that the third studs protrude from the worn tread portion as the tread portion wears against the surface, the third studs being embedded at a radial depth different from the second studs.

According to yet another aspect of the arrangement, each of the second studs is embedded at a first radial depth of the tread portion and each of the third studs is embedded at a second radial depth of the tread portion, the first radial depth being less than the second radial depth.

In accordance with the present invention, a stud configuration for a tire tread includes a first plurality of studs disposed at a first radial depth of the tire tread, a second plurality of studs disposed at a second radial depth of the tire tread, and a third plurality of studs disposed at a third radial depth of the tire tread. The first radial depth is greater than the second radial depth and the second radial depth is greater than the third radial depth.

According to another aspect of the configuration, the first plurality of studs, the second plurality of studs, and the third plurality of studs each have an identical construction.

According to still another aspect of the configuration, the first plurality of studs, the second plurality of studs, and the third plurality of studs each have a differing construction.

According to yet another aspect of the configuration, the first plurality of studs each have a tip end with a first size, the second plurality of studs each have a tip end with a second size, and the third plurality of studs each have a tip end with the first size, the first size being larger than the second size.

According to still another aspect of the configuration, the first plurality of studs each have a tip end with a first size, the second plurality of studs each have a tip end with a second size, and the third plurality of studs each have a tip end with the first size, the second size being larger than the first size.

A stud for use with the present invention may be configured to be inserted into a tread portion of a tire. The stud may include a tip end protruding from the tread portion for contacting a surface, and a base including a flanged bottom portion provided on an end opposite the tip end and extending radially outward, a stump portion provided between the bottom portion and the tip end, and a shank portion interconnecting the stump portion and the bottom portion. The base may be embedded and secured in the tread portion of the tire in which the stud is installed. The bottom portion may have a tear-drop shape consisting of three planar sides and one semi-cylindrical side. The stump portion may have a polygonal shape consisting of three concave sides, two convex sides, and one planar side.

According to another aspect of the stud, the tip end may have a hexagonal-like cross-sectional shape extending radially outward from a radially outermost surface of the stump portion of the base.

According to still another aspect of the stud, the tip end may have a cross-section with three concave surfaces with three planar surfaces.

According to yet another aspect of the stud, the cross-section of the stump portion may include a flat side circumferentially disposed between first and second concave hollows and two convex sides circumferentially separated by a third concave hollow.

According to still another aspect of the stud, the cross-section of the stump portion may include a flat side circumferentially disposed between first and second concave hollows and first and second convex sides circumferentially separated by a third concave hollow. The first concave hollow is adjacent the first convex side and the second concave hollow is adjacent the second convex side.

According to yet another aspect of the stud, the bottom portion may have a tear drop cross-section with three planar sides and one semi-cylindrical side.

According to still another aspect of the stud, the shank portion may have a thinner cross-section compared to the bottom portion.

According to yet another aspect of the stud, the shank portion may have a thinner cross-section compared to the trunk portion.

According to still another aspect of the stud, the shank portion may have an oval-shaped cross-section.

According to yet another aspect of the stud, the tip end may have a radially outermost surface with four generally planar surfaces converging to form an outer point for improving engagement of the stud with an ice surface.

A first stud configuration for a tire tread in accordance with the present invention may include: a first plurality of studs disposed in a first region of the tire tread, the first plurality of studs each having a first orientation; a second plurality of studs disposed in a second region of the tire tread, the second plurality of studs each having a second orientation rotated +90 degrees relative to a radial axis; and a third plurality of studs disposed in a third region of the tire tread, the third plurality of studs each having a third orientation rotated −90 degrees relative to the radial axis.

According to another aspect of the first stud configuration, the first plurality of studs, the second plurality of studs, and the third plurality of studs each may have an identical construction.

According to still another aspect of the first stud configuration, the first region may be a shoulder portion of the tread portion, the second region may be a center portion of the tread portion, and the third region may be another shoulder portion of the tread portion.

According to yet another aspect of the first stud configuration, the first plurality of studs each may have a tip end with a first size, the second plurality of studs each may have a tip end with a second size, and the third plurality of studs each may have a tip end with the first size. The first size may be larger than the second size.

According to still another aspect of the first stud configuration, the first plurality of studs each may have a tip end with a first size, the second plurality of studs each may a tip end with a second size, and the third plurality of studs each may have a tip end with the first size. The second size may be larger than the first size.

A second stud configuration for use with the present invention may include: a first plurality of studs disposed in a first region of the tire tread, the first plurality of studs each having a first orientation; a second plurality of studs disposed in a second region of the tire tread, the second plurality of studs each having a second orientation rotated +45 degrees relative to a radial axis; and a third plurality of studs disposed in a third region of the tire tread, the third plurality of studs each having a third orientation rotated −45 degrees relative to the radial axis.

According to another aspect of the second stud configuration, the first plurality of studs, the second plurality of studs, and the third plurality of studs each may have an identical construction.

According to still another aspect of the second stud configuration, the first region may be a shoulder portion of the tread portion, the second region may be a center portion of the tread portion, and the third region may be another shoulder portion of the tread portion.

According to yet another aspect of the second stud configuration, the first plurality of studs each may have a tip end with a first size, the second plurality of studs each may have a tip end with a second size, and the third plurality of studs each may have a tip end with the first size. The first size may be larger than the second size.

According to still another aspect of the second stud configuration, the first plurality of studs each may have a tip end with a first size, the second plurality of studs each may have a tip end with a second size, and the third plurality of studs each may have a tip end with the first size. The second size may be larger than the first size.

### Definitions

The following definitions are controlling for the present invention.

“Axial” and “Axially” means the lines or directions that are parallel to the axis of rotation of the tire.

“Axially Inward” means in an axial direction toward the equatorial plane.

“Axially Outward” means in an axial direction away from the equatorial plane.

“Bead” or “Bead Core” generally means that part of the tire comprising an annular tensile member of radially inner beads that are associated with holding the tire to the rim.

“Belt Structures” or “Reinforcement Belts” or “Belt Package” means at least two annular layers or plies of parallel cords, woven or unwoven, underlying the tread, unanchored to the bead, and having both left and right cord angles in the range from 18 degrees to 30 degrees relative to the equatorial plane of the tire.

“Carcass” means the tire structure apart from the belt structure, tread, undertread over the plies, but including the beads.

“Circumferential” means circular lines or directions extending along the perimeter of the surface of the annular tread perpendicular to the axial direction; it can also refer to the direction of the sets of adjacent circular curves whose radii define the axial curvature of the tread, as viewed in cross section.

“Directional Tread Pattern” means a tread pattern designed for specific direction of rotation.

“Equatorial Plane” means the plane perpendicular to the tire's axis of rotation and passing through the center of its tread; or the plane containing the circumferential centerline of the tread.

“Footprint” means the contact patch or area of contact of the tire tread with a flat surface under normal load pressure and speed conditions.

“Groove” means an elongated void area in a tread that may extend circumferentially or laterally in the tread in a straight, curved or zigzag manner. It is understood that all groove widths are measured perpendicular to the centerline of the groove.

“Hertz” means number of cycles per second.

“Lateral” means a direction going from one sidewall of the tire towards the other sidewall of the tire.

“Net to gross” means the ratio of the net ground contacting tread surface to the gross area of the tread including the ground contacting tread surface and void spaces comprising grooves, notches and sipes.

“Notch” means a void area of limited length that may be used to modify the variation of net to gross void area at the edges of blocks.

“Ply” means a cord-reinforced layer of rubber coated radially deployed or otherwise parallel cords.

“Radial” and “radially” mean directions radially toward or away from the axis of rotation of the tire.

“Radial Ply Tire” means a belted or circumferentially-restricted pneumatic tire in which at least one ply has cords which extend from bead to bead are laid at cord angles between 65 degrees and 90 degrees with respect to the equatorial plane of the tire.

“Shoulder” means the upper portion of sidewall just below the tread edge.

“Sidewall” means that portion of a tire between the tread and the bead.

“Sipe” means a groove having a width in the range of 0.2 percent to 0.8 percent of the tread width. Sipes are typically formed by steel blades having a 0.4 to 1.6 mm, inserted into a cast or machined mold.

“Tangential” and “Tangentially” refer to segments of circular curves that intersect at a point through which can be drawn a single line that is mutually tangential to both circular segments.

“Tread” means the ground contacting portion of a tire.

“Tread width” (TW) means the greatest axial distance across the tread, when measured (using a footprint of a tire,) laterally from shoulder to shoulder edge, when mounted on the design rim and subjected to a specified load and when inflated to a specified inflation pressure for said load.

“Void Space” means areas of the tread surface comprising grooves, notches and sipes.

### BRIEF DESCRIPTION OF THE DRAWINGS

The present invention will be better understood through reference to the following description and the appended drawings, in which:

FIG. 1 schematically represents an external perspective view of a first stud.

FIG. 2 schematically represents an external perspective view of a second stud.

FIG. 3 schematically represents a radial orthographic view of a tread for use with an arrangement of the first and second studs of FIGS. 1 and 2 in accordance with the present invention.

FIG. 4 schematically represents a detailed radial orthographic view of another stud arrangement in accordance with the present invention.

FIG. 5 schematically represents a cross-sectional view of part of the stud arrangement of FIG. 4.

FIG. 6 schematically represents a cross-sectional view of another part of the stud arrangement of FIG. 4.

### DETAILED DESCRIPTION OF EXAMPLES OF THE PRESENT INVENTION

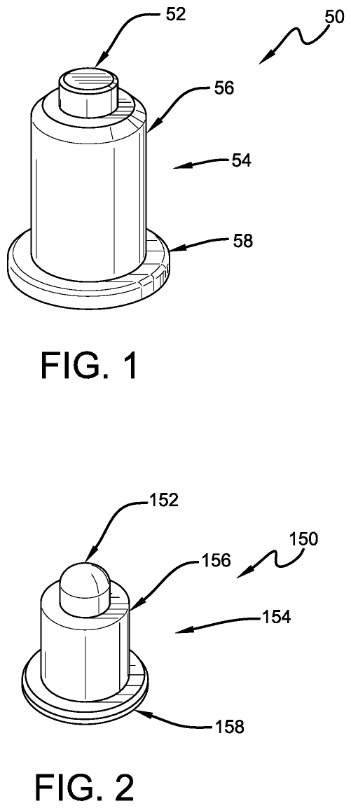

The following is an explanation of a pneumatic or non-pneumatic tire assembly according to the present invention. The assembly may be similar to the pneumatic tire configurations disclosed in U.S. Pat. No. 10,035,382, herein incorporated by reference in its entirety, and U.S. patent application Ser. No. 16/166,207 filed on Oct. 22, 2018, herein incorporated by reference in its entirety. FIG. 1 of U.S. Pat. No. 10,035,382 schematically represents a tire cross-sectional view illustrating a cross-section of a pneumatic tire. The pneumatic tire may be a tire with studs embedded in a tread portion of the pneumatic tire.

The tire circumferential direction explained hereafter refers to the rotation direction (both rolling directions) of a tread surface of a studded tire 10 about a tire rotation axis. The radial direction of the tire refers a direction radiating about a direction extending orthogonally to/from the tire rotation axis. The radially outer side of the studded tire 10 may refer to the side away from the tire rotation axis in the radial direction of the studded tire. The tire width direction may be a direction parallel to the tire rotational axis, and the outer side in the tire width direction may refer to two sides away from a tire center line of the studded tire 10.

A studded tire 10, in accordance with the present invention, may include a carcass ply layer, a belt layer, and bead cores which serve as a frame for the studded tire. The studded tire 10 may further include a tread member 18, sidewall members, bead filler members, rim cushion members, and an innerliner member around the frame for the studded tire.

The carcass ply layer may be formed in a toroidal shape wound between a pair of circular ring-shaped bead cores, and may include rubber-coated organic fiber carcass ply members. The carcass ply layer may be configured from multiple carcass ply members or a single carcass ply member. The belt layer may be provided on the outer side in the tire radial direction of the carcass ply layer and configured from two belt members. The belt layer may be constructed of rubber-coated steel cords arranged at a predetermined angle, such as 20 to 30 degrees, relative to the tire circumferential direction. The inclination direction of the steel cords of the two layers of the belt members may be opposite each other.

The tread member 18 may be disposed on an outer side in the tire radial direction of the belt layer. The sidewall members may be connected to two sides of the tread member 18 to form two sidewalls. The tread member 18 may be configured from two layers of rubber, an upper tread member disposed on an outer side in the tire radial direction, and a lower tread member disposed on an inner side in the tire radial direction. The rim cushion members may be disposed at inner sides in the tire radial direction of the sidewall members and come into contact with a rim on which the studded tire 10 may be fitted. A bead filler material may be disposed between a portion of the carcass ply layer before the carcass ply layer is wound around the bead cores and a portion of the carcass ply layer. The innerliner member may be disposed on an inner surface of the studded tire 10 adjacent a tire cavity region that is filled with gas enclosed by the studded tire and the rim. The studded tire 10 may have this tire structure or any other suitable structure, pneumatic and/or non-pneumatic.

FIG. 1 shows an external perspective view of a first stud 50 for use with the present invention. The first stud 50 may include a radially outer flat tip end 52 and a base 54 for partially inserting into corresponding recesses in the tread member 18. The base 54 may thus be partially embedded inside a stud pin installation hole in the tread portion 18 of the studded tire 10 in which it is installed. The first stud 50 may be secured to the studded tire 10 by side surfaces of the stud pin installation hole pressing and clamping onto part of the base 54 (See FIGS. 5 and 6).

The base 54 may include a bottom portion 58 and a cylindrical stump portion 56 radially interconnecting the bottom portion and the tip end 52. The bottom portion 58 may be located at the radially opposite end of the tip end 52. The first stud 50 may thus be formed from the bottom portion 58, the stump portion 56, and tip end 52 in that radial ascending order.

FIG. 2 shows an external perspective view of a smaller second stud 150 for use with the present invention. The second stud 150 may include a radially outer spherical tip end 152 and a base 154 for partially inserting into corresponding recesses in the tread member 18. The base 154 may thus be partially embedded inside a stud pin installation hole in the tread portion 18 of the studded tire 10 in which it is installed. The second stud 150 may be secured to the studded tire 10 by side surfaces of the stud pin installation hole pressing and clamping onto part of the base 154 (See FIGS. 5 and 6).

The base 154 may include a bottom portion 158 and a cylindrical stump portion 156 radially interconnecting the bottom portion and the tip end 152. The bottom portion 158 may be located at the radially opposite end of the tip end 152. The first stud 150 may thus be formed from the bottom portion 158, the stump portion 156, and tip end 152 in that radial ascending order.

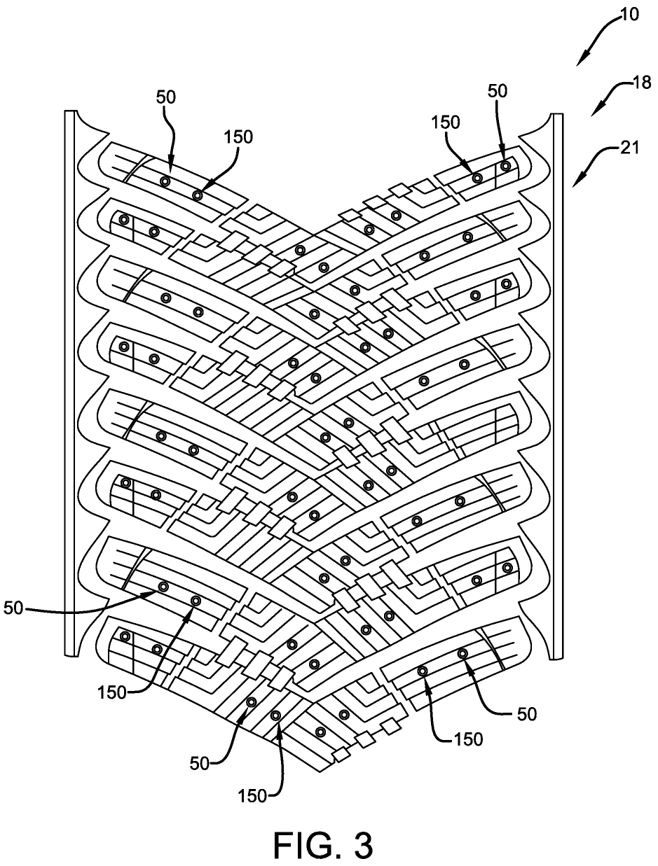

FIG. 3 shows a radial orthographic view of the tread portion 18 for use with a first arrangement 21 of the first and second studs 50, 150 of FIGS. 1 and 2 in accordance with the present invention. The first arrangement 21 provides pairs of studs, each pair having one first stud 50 and one second stud 150.

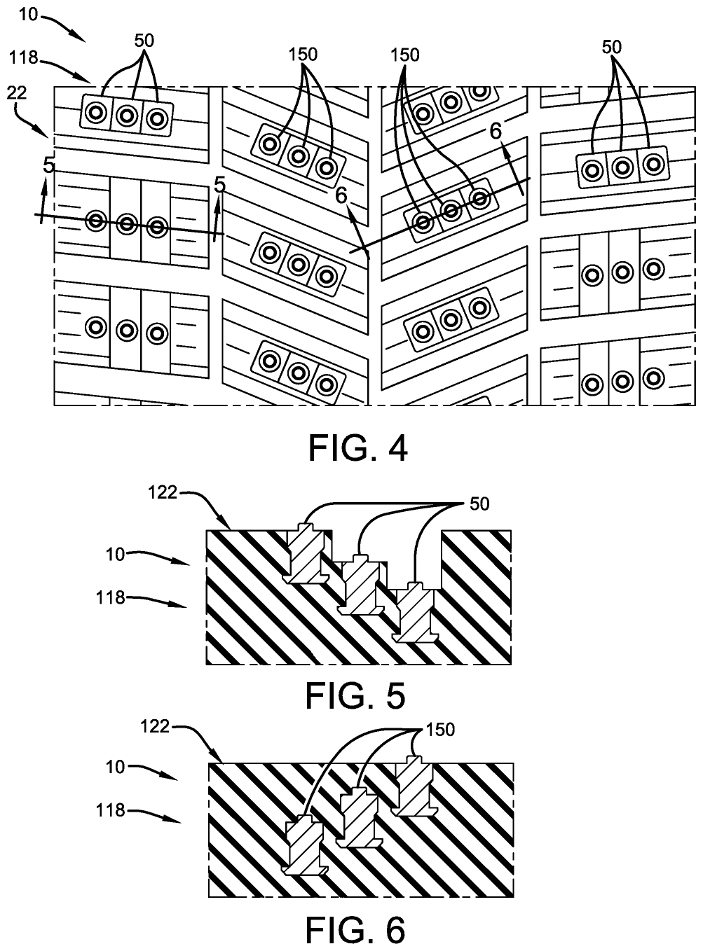

FIG. 4 shows a radial orthographic view of another tread portion 118 for use with a second arrangement 22 of the first and second studs 50, 150 of FIGS. 1 and 2 in accordance with the present invention. The second arrangement 22 provides triplets of studs, each triplet having three first studs 50 or three second studs 150. As shown in FIGS. 5 and 6, each triplet 50 or 150 may have the three studs 50 or 150 disposed at differing radial depths beneath a radially outer surface 122 of the tread 118. Further, the triplets may be disposed such that the tip ends 52 or 152 protrude radially outside of the mass of the tread portion 118 (FIG. 5).

Alternatively, the triplets may be disposed such that the tip end 52 or 152 of only the radially outer most studs 50 or 150 protrude radially outside of the mass of the unworn tread portion 118 (FIG. 6). The other two tip ends 52 or 152 may be at a radial depth such that the tip ends 52 or 152 are embedded in the mass of the tread portion 118 until the tread portion 118 wears over time and use of the studded tire 10. The arrangement 22 thus allows the radially inner studs 50 or 150 to take over as the radially outer studs are worn away. Thus, brand new effective studs 50 or 150 may appear at a certain mileage/wear of the tread 118.

The arrangements 21, 22 of such studs 50, 150, according to the present invention, have been described above in exemplary detail. However, a tire, a stud, and/or arrangement according to the present invention may not be limited to the above examples and may be modified and given various substitutions in accordance with the spirit and the scope of the present invention.

What is claimed:

1. An arrangement of studs inserted into a tread portion of a tire, the arrangement comprising:
a plurality of first studs protruding from an unworn tread portion for contacting a surface; and
a plurality of second studs embedded in the tread portion such that the second studs protrude from a worn tread portion as the tread portion wears against the surface.

2. The arrangement as set forth in claim 1 wherein the first studs have radially outermost flat tip ends for contacting the surface.

3. The arrangement as set forth in claim 1 wherein the first studs have radially outermost spherical tip ends.

4. The arrangement as set forth in claim 1 wherein the second studs have radially outermost flat tip ends for contacting the surface.

5. The arrangement as set forth in claim 1 wherein the second studs have radially outermost spherical tip ends.

6. The arrangement as set forth in claim 1 wherein the first studs have a cylindrical stump portion.

7. The arrangement as set forth in claim 1 wherein the first studs have radially outermost flat tip ends and the second studs have radially outermost spherical tip ends.

8. The arrangement as set forth in claim 1 wherein the first studs have radially outermost spherical tip ends and the second studs have radially outermost flat tip ends.

9. The arrangement as set forth in claim 1 further including a plurality of third studs embedded in the tread portion such that the third studs protrude from the worn tread portion as the tread portion wears against the surface, the third studs being embedded at a radial depth different from the second studs.

10. The arrangement as set forth in claim 1 wherein each of the second studs is embedded at a first radial depth of the tread portion and the each of the third studs is embedded at a second radial depth of the tread portion, the first radial depth being less than the second radial depth.

11. A stud configuration for a tire tread comprising:
a first plurality of studs disposed at a first radial depth of the tire tread;
a second plurality of studs disposed at a second radial depth of the tire tread; and
a third plurality of studs disposed at a third radial depth of the tire tread, the first radial depth being greater than the second radial depth and the second radial depth being greater than the third radial depth.

12. The stud configuration as set forth in claim 11 wherein the first plurality of studs, the second plurality of studs, and the third plurality of studs each have an identical construction.

13. The stud configuration as set forth in claim 11 wherein the first plurality of studs, the second plurality of studs, and the third plurality of studs each have a differing construction.

14. The stud configuration as set forth in claim 11 wherein the first plurality of studs each have a tip end with a first size, the second plurality of studs each have a tip end with a second size, and the third plurality of studs each have a tip end with the first size, the first size being larger than the second size.

15. The stud configuration as set forth in claim 11 wherein the first plurality of studs each have a tip end with a first size, the second plurality of studs each have a tip end with a second size, and the third plurality of studs each have a tip end with the first size, the second size being larger than the first size.
